(19) United States
(12) Patent Application Publication
(10) Pub. No.: US 2013/0254894 A1
(43) Pub. Date: Sep. 26, 2013

(54) INFORMATION PROCESSING DEVICE, NON-TRANSITORY COMPUTER READABLE MEDIUM, AND INFORMATION PROCESSING METHOD

(71) Applicant: FUJI XEROX CO., LTD., Tokyo (JP)

(72) Inventor: Nobushige ASAHI, Yokohama-shi (JP)

(73) Assignee: FUJI XEROX CO., LTD., Tokyo (JP)

(21) Appl. No.: 13/622,825

(22) Filed: Sep. 19, 2012

(30) Foreign Application Priority Data
Mar. 23, 2012 (JP) 2012-067316

(51) Int. Cl. G06F 21/00

(52) U.S. Cl. 726/25

(57) ABSTRACT

An information processing device includes an importance generation unit that generates importance information indicating an importance of an information processing apparatus on the basis of first apparatus information regarding the information processing apparatus, collected from the information processing apparatus, a crisis degree generation unit that generates crisis degree information indicating a level of a crisis which the information processing apparatus possibly suffers on the basis of second apparatus information regarding the information processing apparatus, collected from the information processing apparatus, and an evaluation unit that calculates an evaluation value on the basis of the importance information generated by the importance generation unit and the crisis degree information generated by the crisis degree generation unit.

### CROSS-REFERENCE TO RELATED APPLICATIONS

This application is based on and claims priority under 35 USC 119 from Japanese Patent Application No. 2012-067316 filed Mar. 23, 2012.

### BACKGROUND

### Technical Field

The present invention relates to an information processing device, a non-transitory computer readable medium, and an information processing method.

### SUMMARY

According to an aspect of the invention, there is provided an information processing device including an importance generation unit that generates importance information indicating an importance of an information processing apparatus on the basis of first apparatus information regarding the information processing apparatus, collected from the information processing apparatus; a crisis degree generation unit that generates crisis degree information indicating a level of a crisis which the information processing apparatus may possibly suffer on the basis of second apparatus information regarding the information processing apparatus, collected from the information processing apparatus; and an evaluation unit that calculates an evaluation value on the basis of the importance information generated by the importance generation unit and the crisis degree information generated by the crisis degree generation unit.

### BRIEF DESCRIPTION OF THE DRAWINGS

Exemplary embodiments of the present invention will be described in detail based on the following figures, wherein:

FIG. 1 is a diagram illustrating an information processing system;

FIG. 2 is a diagram illustrating apparatus information;

FIG. 3 is a diagram illustrating company information;

FIG. 4 is a diagram illustrating customer information;

FIG. 5 is a diagram illustrating functions realized in an information analysis device;

FIG. 6 is a diagram illustrating a configuration of an importance determination unit;

FIG. 7A is a diagram illustrating a hardware evaluation table;

FIG. 7B is a diagram illustrating a hardware evaluation table;

FIG. 7C is a diagram illustrating a hardware evaluation table;

FIG. 7D is a diagram illustrating a hardware evaluation table;

FIG. 8 is a diagram illustrating a correction control value evaluation table;

FIG. 9 is a diagram illustrating a software evaluation table;

FIG. 10 is a diagram illustrating a business type software table;

FIG. 11 is a diagram illustrating a software evaluation table;

FIG. 12 is a diagram illustrating a configuration of a threat determination unit;

FIG. 13A is a diagram illustrating an installation evaluation table;

FIG. 13B is a diagram illustrating a virus definition evaluation table;

FIG. 13C is a diagram illustrating a number-of-mountings evaluation table;

FIG. 14A is a diagram illustrating a CPU temperature evaluation table;

FIG. 14B is a diagram illustrating an average load evaluation table;

FIG. 14C is a diagram illustrating a hard disk temperature evaluation table;

FIG. 14D is a diagram illustrating a number-of-errors evaluation table;

FIG. 15 is a flowchart illustrating a correction process;

FIG. 16A is a diagram illustrating a file sharing software evaluation table;

FIG. 16B is a diagram illustrating a times-of-writings evaluation table; and

FIG. 16C is a diagram illustrating a number-of-ports evaluation table.

### DETAILED DESCRIPTION

Hereinafter, exemplary embodiments of the invention will be described in detail with reference to the drawings.

Besides, “EXCEL” and “POWERPOINT” are trademarks registered by Microsoft, “PHOTOSHOP” is a trademark registered by Adobe, and “SHADE” is a trademark registered by e-frontier.

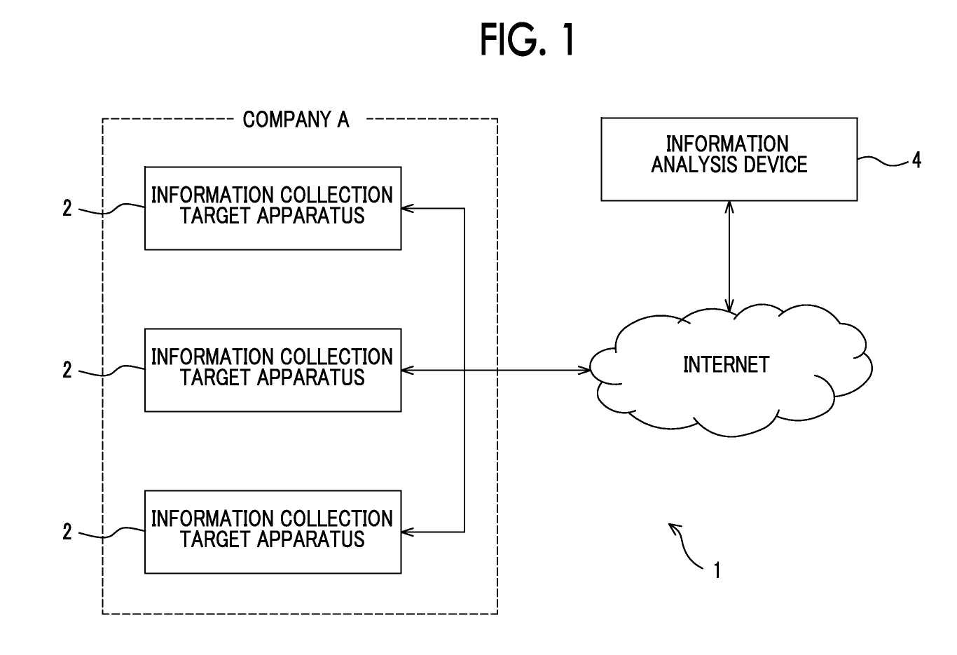

FIG. 1 is a diagram illustrating an information processing system 1 according to an exemplary embodiment of the invention. As shown in the same figure, the information processing system 1 includes plural information collection target apparatuses 2 possessed by a company A (user) and an information analysis device 4. The information collection target apparatuses 2 and the information analysis device 4 are connected to the Internet.

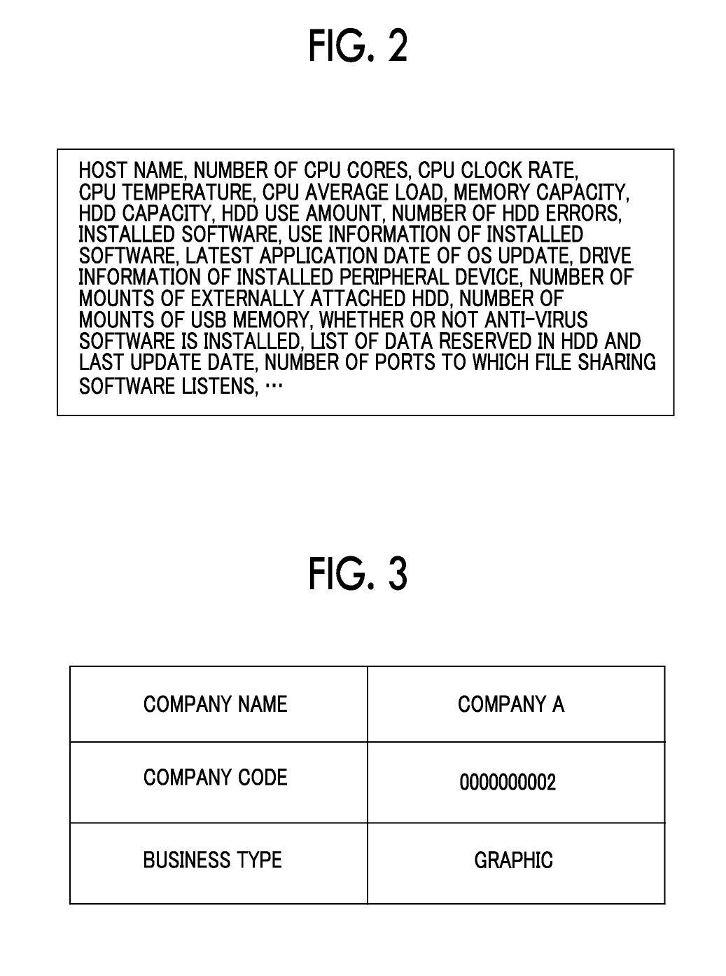

The information collection target apparatuses 2 are personal computers used by employees of the company A. An information collection program which is distributed from a company X providing an information system service to the company A is installed in each of the information collection target apparatuses 2. The information collection program periodically (here, once a week) collects a variety of apparatus information regarding the information collection target apparatuses 2. In a case of the exemplary embodiment, the apparatus information exemplified in FIG. 2 is collected. In other words, as the apparatus information, there is a collection of the host name of the information collection target apparatus 2, the number of CPU cores, the CPU clock rate, CPU temperature, CPU average load, a memory capacity, a hard disk capacity, a hard disk use amount, the number of operating years of the hard disk, hard disk temperature, the number of hard disk errors, installed software, the number of activations of the installed software per day, the latest application date of OS update, the number of mounts of an externally attached hard disk per day, the number of mounts of a USB storage device per day, the number of data writings in the USB storage device per day, whether or not anti-virus software is installed, the reset date of a virus definition file of the anti-virus software, a list of data reserved on the hard disk and the last update date, whether or not file sharing software is installed, the number of ports to which the file sharing software listens, and the like.

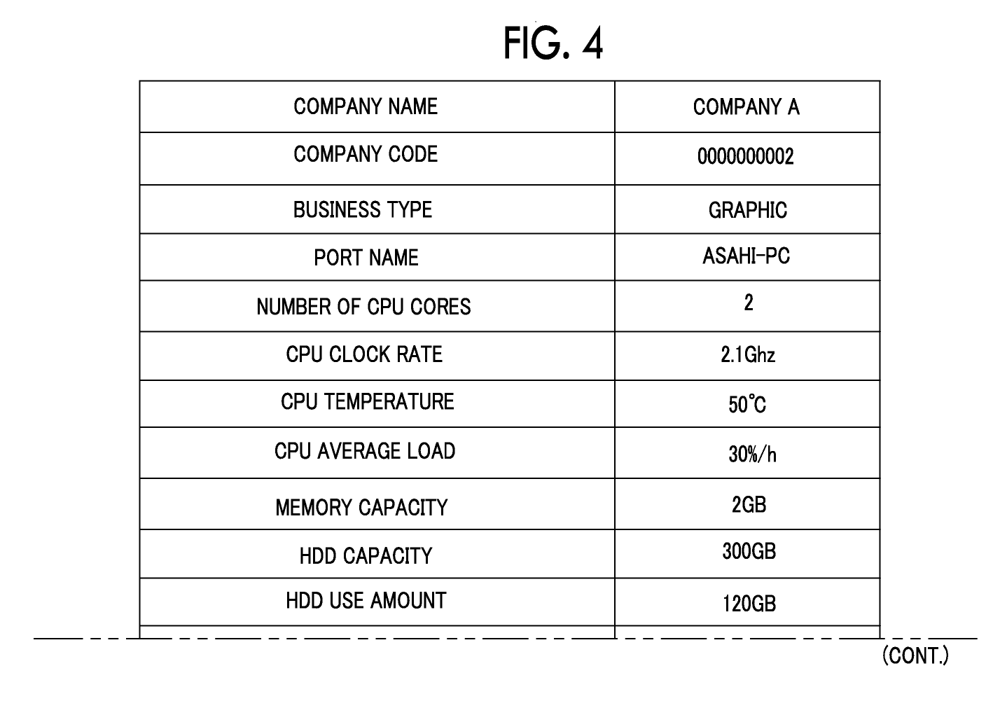

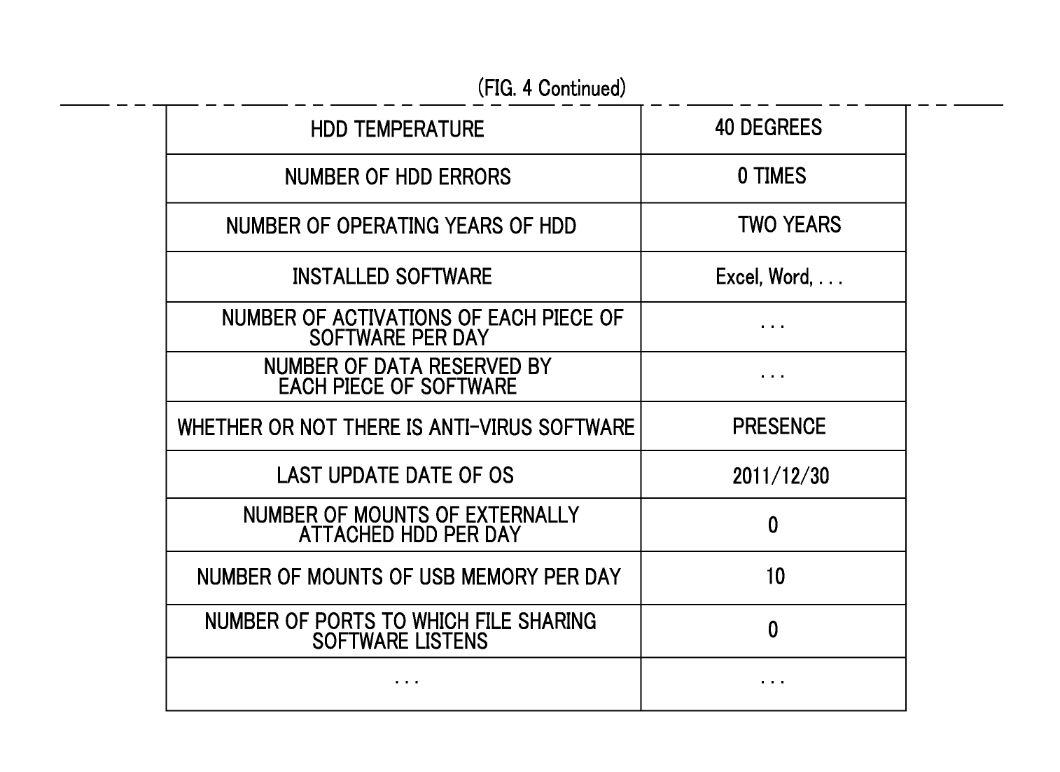

In addition, the information collection program does not only collect a variety of apparatus information but also reads company information regarding the company A and transmits customer information including the collected apparatus information and the company information to the information analysis device 4. FIG. 3 exemplifies the company information. As shown in the same figure, the company information includes the company name of the company A, a company code of the company A, and a business type of the company A. In addition, FIG. 4 exemplifies the customer information.

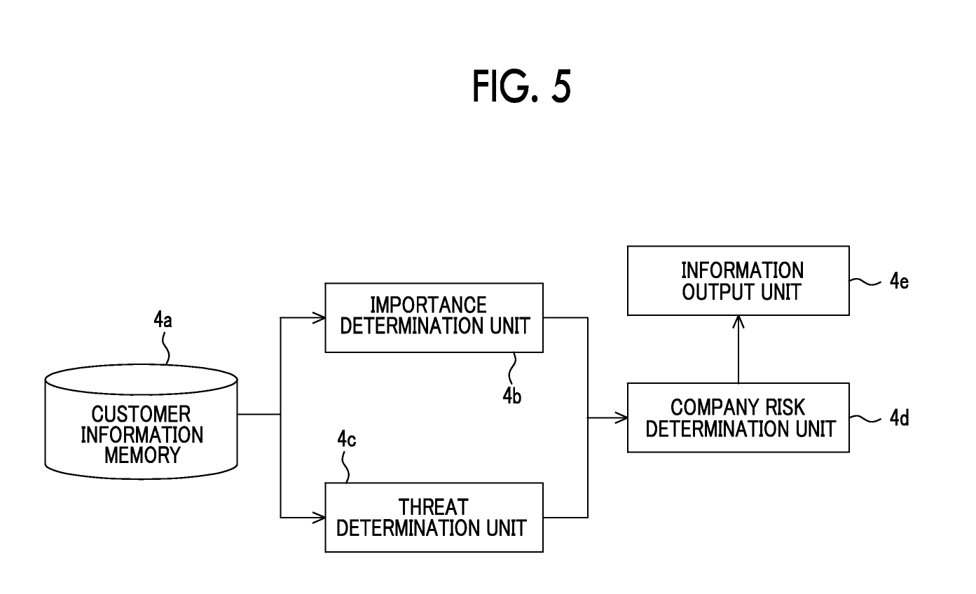

In addition, the information analysis device 4 is a server possessed by the company X, and includes a microprocessor, a main storage device, a hard disk, a display, a network interface, and the like. The main storage device stores an information analysis program which is read from a computer readable information storage medium such as a DVD (registered trademark)-ROM, and various functions are realized in the information analysis device 4 by the microprocessor executing the information analysis program. In other words, as exemplified in FIG. 5, a customer information memory 4a, an importance determination unit 4b (importance generation unit), a threat determination unit 4c (crisis degree generation unit), a company risk determination unit 4d (evaluation unit), and an information output unit 4e are realized in the information analysis device 4. In addition, the information analysis program may be supplied from a communication network such as a network and be stored in the main storage device.

The customer information memory 4a is realized by the hard disk, and stores customer information transmitted from each of the information collection target apparatuses 2. The importance determination unit 4b, the threat determination unit 4c, the company risk determination unit 4d, and the information output unit 4e are realized by the microprocessor.

For each of the information collection target apparatuses 2 of the company A, an importance of the information collection target apparatus 2 in the company A, and a threat degree indicating a level of a crisis which the information collection target apparatus 2 faces or may possibly suffer, are determined in the information analysis device 4. That is to say, each piece of the customer information stored in the customer information memory 4a is sequentially selected as noted customer information, and the importance determination unit 4b and the threat determination unit 4c perform the following processes for the noted customer information.

Importance Determination Unit

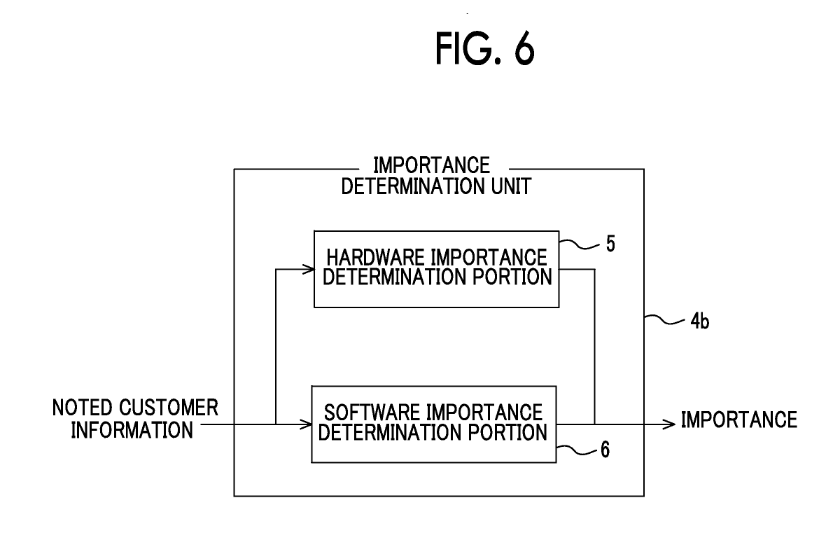

First, the importance determination unit 4b will be described. The importance determination unit 4b determines an importance of the information collection target apparatus 2 (hereinafter, referred to as an information collection target apparatus X) which is a transmission source of the noted customer information in the company A on the basis of the apparatus information of the noted customer information. Specifically, the importance determination unit 4b includes, as shown in FIG. 6, a hardware importance determination portion 5 which determines an importance of the information collection target apparatus X from the viewpoint of a hardware specification, and a software importance determination portion 6 which determines an importance of the information collection target apparatus X from the viewpoint of software installed in the information collection target apparatus X.

The hardware importance determination portion 5 determines an importance on the basis of hardware specification information (that is, the “number of CPU cores”, the “CPU clock rate”, the “memory capacity”, and the “hard disk capacity”) which is apparatus information indicating a hardware specification of the information collection target apparatus X in the apparatus information of the noted customer information. More specifically, first, the hardware importance determination portion 5 calculates an evaluation value which is a numerical value indicating an evaluation of a value of the hardware specification information for each piece of the hardware specification information. Specifically, the hardware importance determination portion 5 sequentially selects each piece of the hardware specification information as noted hardware specification information and calculates an evaluation value in relation to the noted hardware specification information. In addition, the hardware importance determination portion 5 calculates a product of the respective calculated evaluation values as a specification importance.

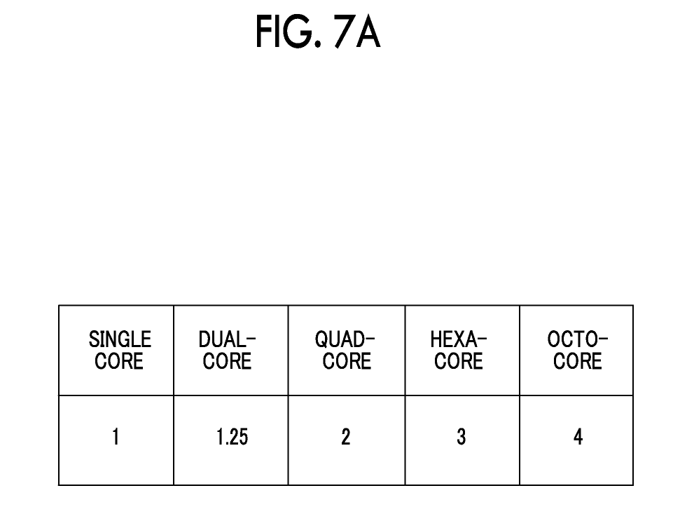

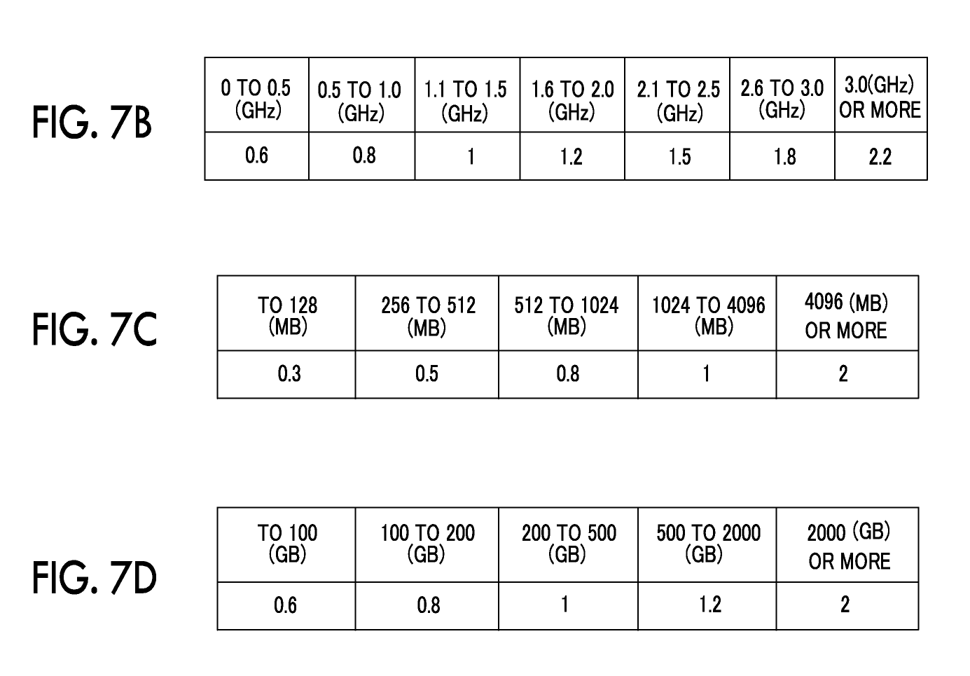

In addition, the calculation of an evaluation value is performed as described below. That is to say, first, the hardware importance determination portion 5 reads a hardware evaluation table which holds conditions regarding values of the noted hardware specification information and fundamental evaluation values so as to be correlated with each other, from the hard disk. For example, in a case where the noted hardware specification information is the “number of CPU cores”, the hardware evaluation table exemplified in FIG. 7A is read, and, in a case where the noted hardware specification information is the “CPU clock rate”, the hardware evaluation table exemplified in FIG. 7B is read. In addition, for example, in a case where the noted hardware specification information is a “memory capacity”, the hardware evaluation table exemplified in FIG. 7C is read, and, in a case where the noted hardware specification information is a “hard disk capacity”, the hardware evaluation table exemplified in FIG. 7D is read.

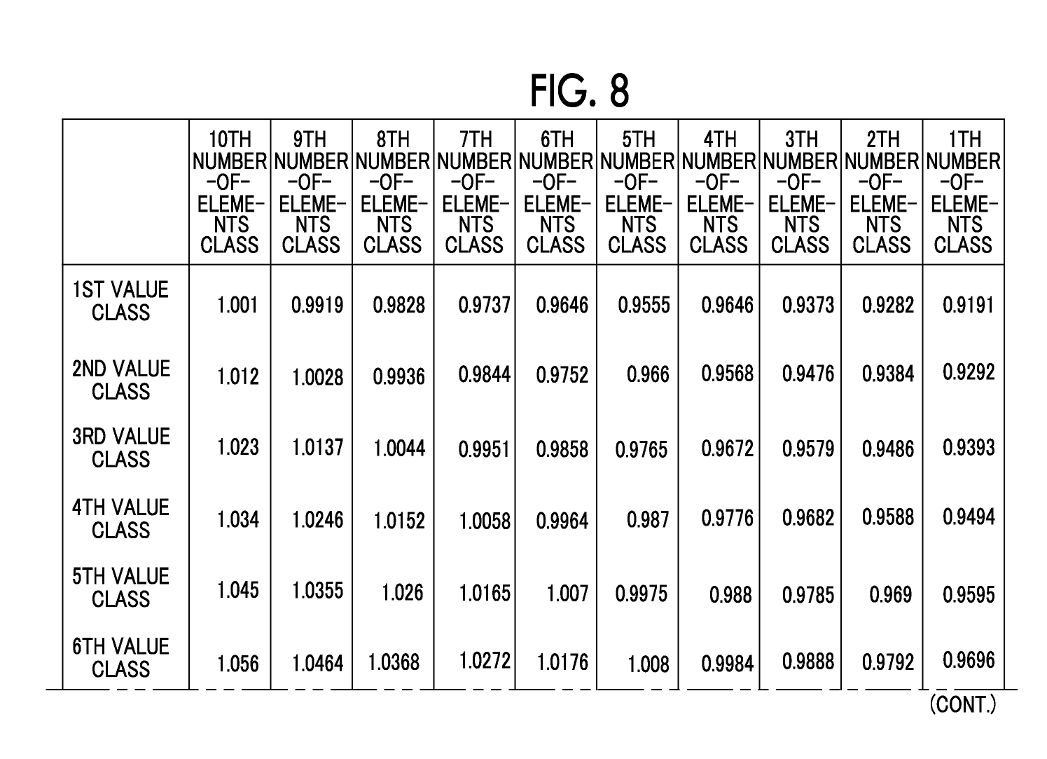

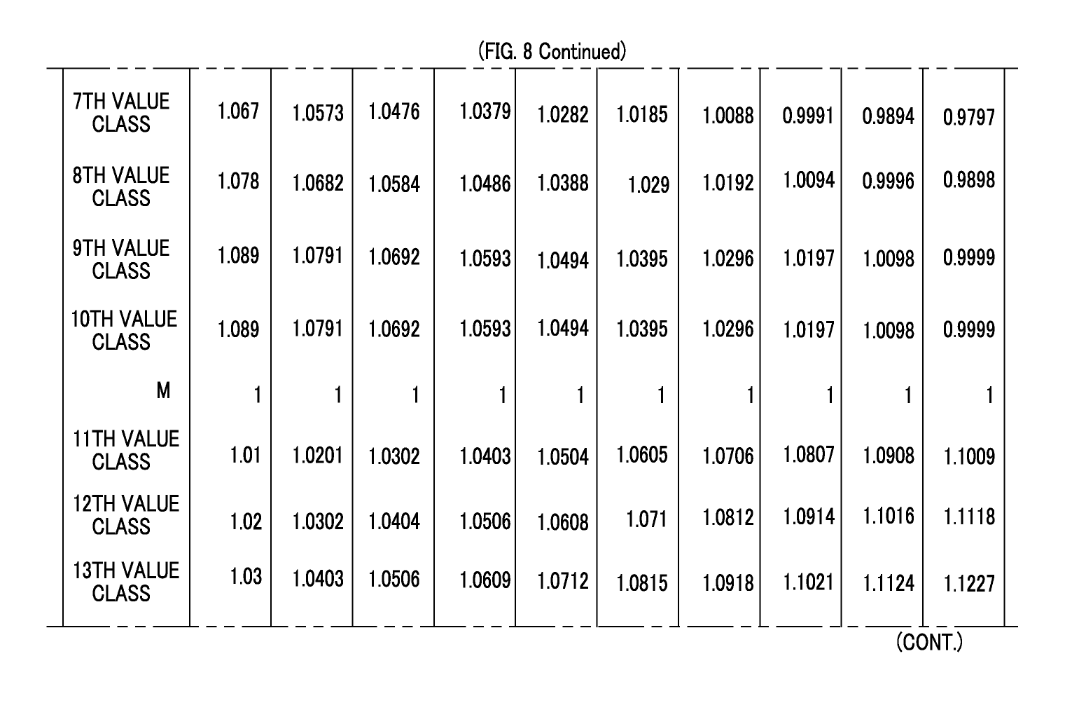

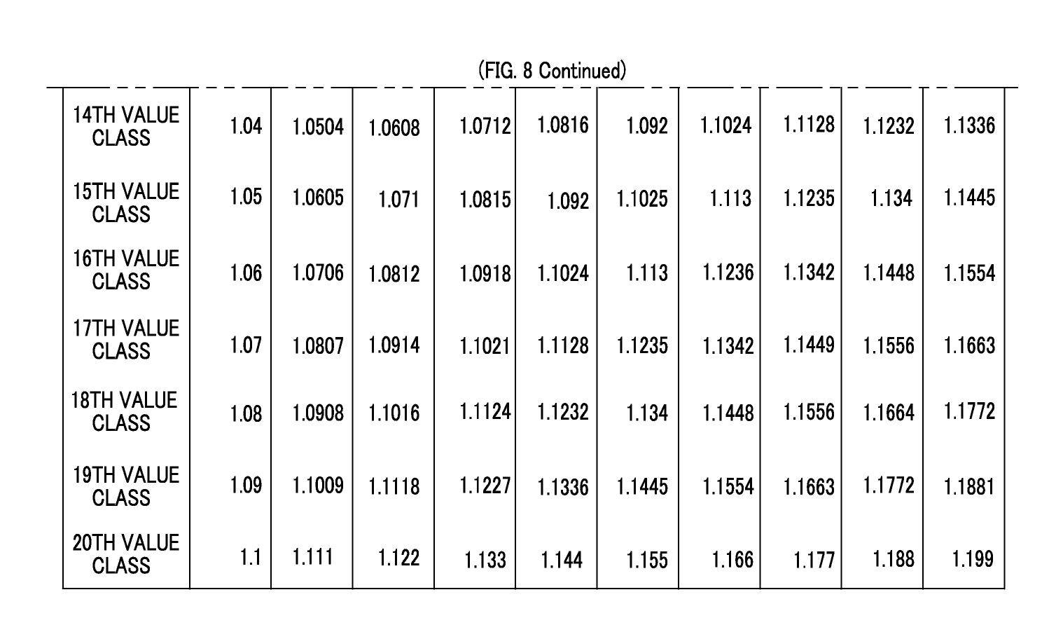

In addition, the hardware importance determination portion 5 reads all the pieces of customer information including the noted customer information from the customer information memory 4a, calculates an average value “M” of values of the noted hardware specification information of the respective pieces of customer information, and specifies a value “N” of which a difference from the average value M is the maximum of values of the noted hardware specification information of the respective pieces of customer information. Further, the hardware importance determination portion 5 sets a difference between the value “N” and the average value “M” as “Δ”, and equally divides a numerical value range from a value “M−Δ” to a value “M+Δ” into twenty numerical value ranges called a value class. Furthermore, the hardware importance determination portion 5 specifies a largest value class of which the number of elements is the largest of the twenty value classes, and equally divides a numerical value range from “0” to the number “L” of elements of the largest value class into ten numerical value ranges called a number-of-elements class. In addition, the hardware importance determination portion 5 specifies a noted value class which is a value class to which a value of the noted hardware specification information of the noted customer information belongs and a noted number-of-elements class which is a number-of-elements class to which the number of elements of the noted value class belongs, and then reads a correction control value table from the hard disk. FIG. 8 exemplifies the correction control value evaluation table. As shown in the same figure, the correction control value table holds a correction control value which is numerical value information in correlation with a combination of the value class and the number-of-elements class.

The hardware importance determination portion 5 specifies a fundamental evaluation value correlated with a condition which is satisfied by a value of the noted hardware specification information of the noted customer information and a correction control value correlated with a combination of the noted value class and the noted number-of-elements class, and calculates a product of the specified fundamental evaluation value and correction control value as an evaluation value. In this way, the evaluation value is calculated.

The software importance determination portion 6 determines an importance on the basis of the “installed software” in the apparatus information of the noted customer information. More specifically, first, the software importance determination portion 6 calculates an evaluation value which is a numerical value indicating an evaluation of software for each piece of software indicated by the “installed software” of the noted customer information. Specifically, the software importance determination portion 6 sequentially selects each piece of software indicated by the “installed software” of the noted customer information as noted software, and calculates an evaluation value in relation to the noted software. In addition, the software importance determination portion 6 calculates a sum of the calculated evaluation values as a software importance. A sum of the software importance calculated in this way and the specification importance is an importance of the information collection target apparatus X.

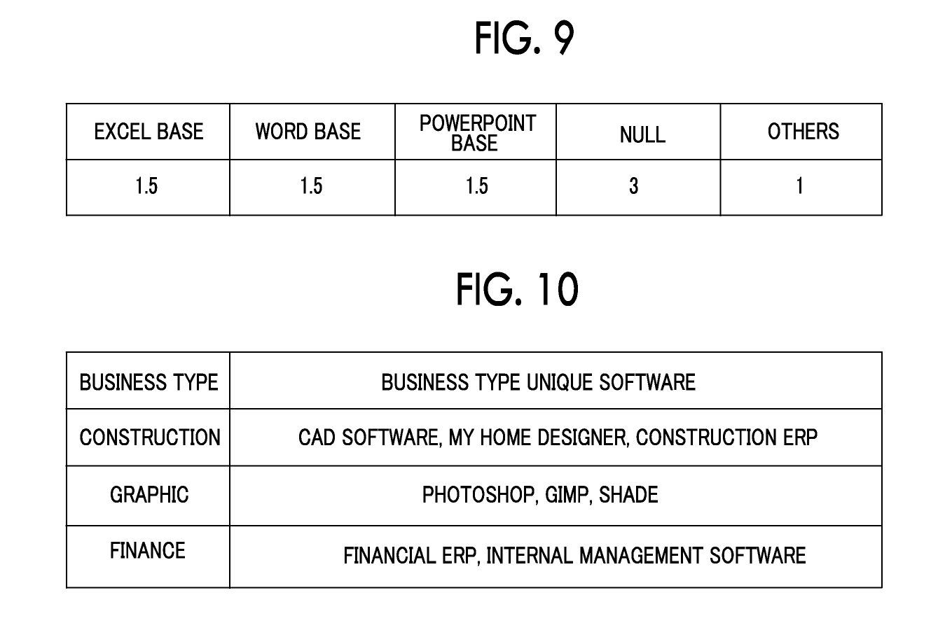

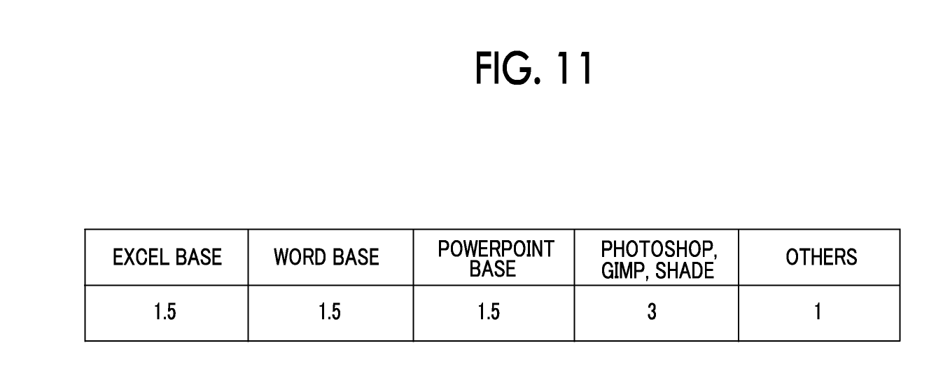

In addition, the calculation of an evaluation value is performed as described below. That is to say, first, the software importance determination portion 6 performs a preprocess for calculating an evaluation value. In other words, the software importance determination portion 6 reads a software evaluation table which holds software type candidates and fundamental evaluation values in correlation with each other from the hard disk. FIG. 9 exemplifies the table. As shown in the same figure, a value of one candidate is set to a “null” value in the software evaluation table. In addition, the software importance determination portion 6 reads a business type software table which holds conditions regarding business types of companies and at least one software type in correlation with each other from the hard disk. FIG. 10 exemplifies the business type software table. As shown in FIG. 10, in relation to a business type of a company, software unique to the corresponding business type is correlated. In addition, the software importance determination portion 6 (attribute specifying unit) specifies a business type of the company A from the “business type” of the noted customer information, and updates the “null” value of the software evaluation table to a software type correlated with a condition which is satisfied by the specified business type. FIG. 11 exemplifies the updated software evaluation table. The above description relates to the preprocess.

The software importance determination portion 6 calculates an evaluation value as described below. That is to say, the software importance determination portion 6 determines whether or not a candidate is the same as noted software for each of the software type candidates held in the software evaluation table, and thereby specifies the same candidate as the noted software among the software type candidates held in the software evaluation table. In addition, the software importance determination portion 6 calculates a product of a fundamental evaluation value correlated with the specified candidate and the “number of activations of noted software per day” of the noted customer information as an evaluation value. Since the company A is engaged in the graphic business, if the noted software is software unique to the graphic business, the fundamental evaluation value “3” is selected, and if the noted software is not software unique to the graphic business, the fundamental evaluation value “1” is selected.

Threat Determination Unit

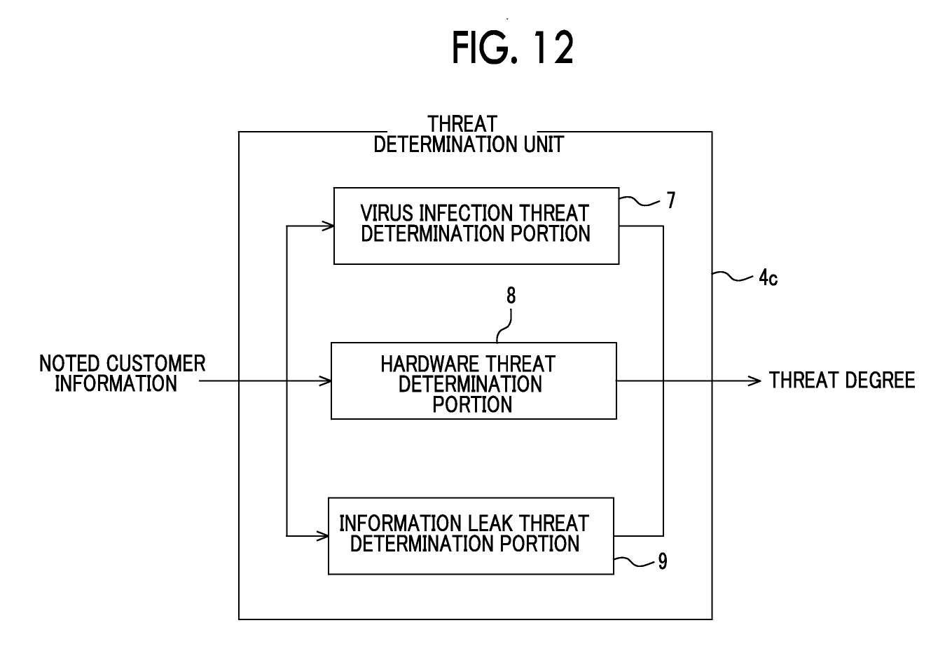

Next, the threat determination unit 4c will be described. The threat determination unit 4c determines a threat degree indicating a level of a crisis which the information collection target apparatus X which is a transmission source of the noted customer information faces or the information collection target apparatus X may possibly suffer on the basis of the apparatus information of the noted customer information. Specifically, the threat determination unit 4c includes, as shown in FIG. 12, a virus infection threat determination portion 7 which determines a threat degree from the viewpoint of virus infection, a hardware threat determination portion 8 which determines a threat degree from the viewpoint of hardware usage, and an information leak threat determination portion 9 which determines a threat degree from the viewpoint of information leak.

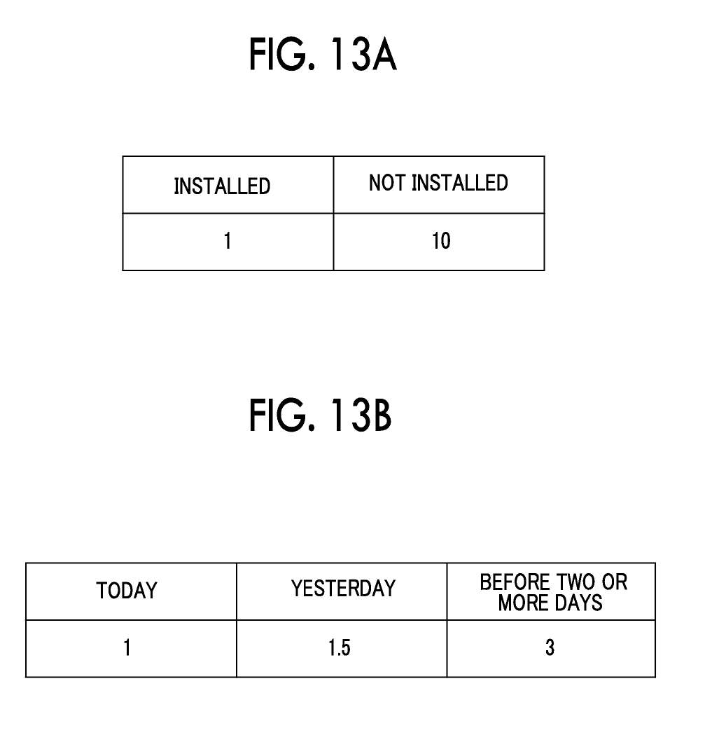

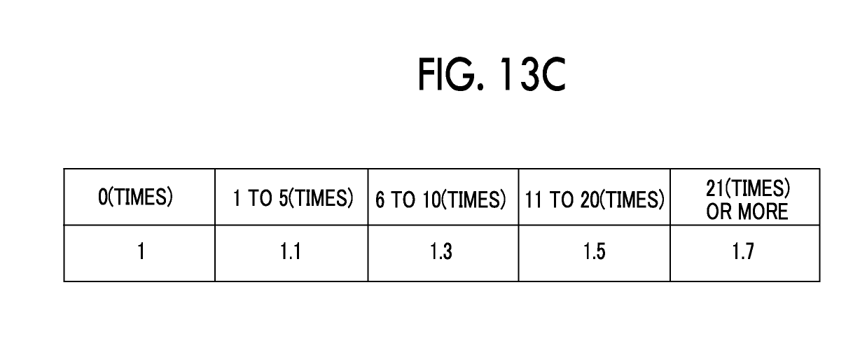

The virus infection threat determination portion 7 determines a threat degree on the basis of the “number of mounts of a USB storage device per day”, the “whether or not anti-virus software is installed”, and the “reset date of a virus definition file of anti-virus software” in the apparatus information of the noted customer information. More specifically, the virus infection threat determination portion 7 reads an installation evaluation table which holds fundamental evaluation values in correlation with conditions regarding values of the apparatus information “whether or not anti-virus software is installed” from the hard disk, and acquires a fundamental evaluation value correlated with a condition which is satisfied by a value of the “whether or not anti-virus software is installed” of the noted customer information. FIG. 13A exemplifies the installation evaluation table. Further, the virus infection threat determination portion 7 reads a virus definition evaluation table which holds fundamental evaluation values in correlation with conditions regarding values of the apparatus information “reset date of a virus definition file of anti-virus software” from the hard disk, and acquires a fundamental evaluation value correlated with a condition which is satisfied by a value of the “reset date of a virus definition file of anti-virus software” of the noted customer information. FIG. 13B exemplifies the virus definition evaluation table. In addition, the virus infection threat determination portion 7 reads a number-of-mountings evaluation table which holds fundamental evaluation values in correlation with conditions regarding values of the apparatus information “number of mounts of a USB storage device per day” from the hard disk, and acquires a fundamental evaluation value correlated with a condition which is satisfied by a value of the “number of mounts of a USB storage device per day” of the noted customer information. FIG. 13C exemplifies the number-of-mountings evaluation table. The virus infection threat determination portion 7 calculates a product of the fundamental evaluation values acquired from the installation evaluation table, the virus definition evaluation table, and the number-of-mountings evaluation table as a virus infection threat degree.

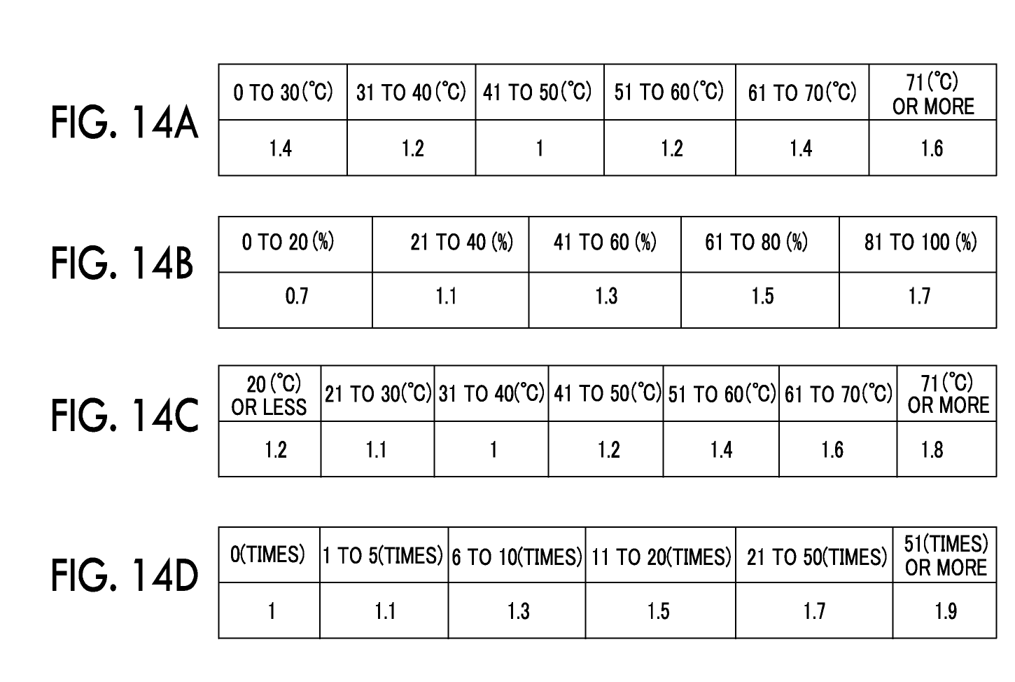

In addition, the hardware threat determination portion 8 determines a threat degree on the basis of usage information (that is, the “CPU temperature”, the “CPU average load”, the “hard disk temperature”, the “number of operating years of the hard disk”, and the “number of hard disk errors”) which is apparatus information indicating usage of each piece of hardware of the information collection target apparatus X in the apparatus information of the noted customer information. More specifically, the hardware threat determination portion reads a CPU temperature evaluation table which holds fundamental evaluation values in correlation with conditions regarding values of the usage information “CPU temperature” from the hard disk, and acquires a fundamental evaluation value correlated with a condition which is satisfied by a value of the “CPU temperature” of the noted customer information. FIG. 14A exemplifies the CPU temperature evaluation table. In addition, the hardware threat determination portion 8 reads an average load evaluation table which holds fundamental evaluation values in correlation with conditions regarding values of the usage information “CPU average load” from the hard disk, and acquires a fundamental evaluation value correlated with a condition which is satisfied by a value of the “CPU average load” of the noted customer information. FIG. 14B exemplifies the average load evaluation table. Further, the hardware threat determination portion 8 reads a hard disk temperature evaluation table which holds fundamental evaluation values in correlation with conditions regarding values of the usage information “hard disk temperature” from the hard disk, and acquires a fundamental evaluation value correlated with a condition which is satisfied by a value of the “hard disk temperature” of the noted customer information. FIG. 14C exemplifies the hard disk temperature evaluation table. Furthermore, the hardware threat determination portion 8 reads a number-of-errors evaluation table which holds fundamental evaluation values in correlation with conditions regarding values of the usage information “number of hard disk errors” from the hard disk, and acquires a fundamental evaluation value correlated with a condition which is satisfied by a value of the “number of hard disk errors” of the noted customer information. FIG. 14D exemplifies the number-of-errors evaluation table. The hardware threat determination portion 8 calculates a product of the fundamental evaluation values acquired from the CPU temperature evaluation table, the average load evaluation table, the hard disk temperature evaluation table, and the number-of-errors evaluation table, and a value of the “number of operating years of the hard disk”, as a hardware threat degree.

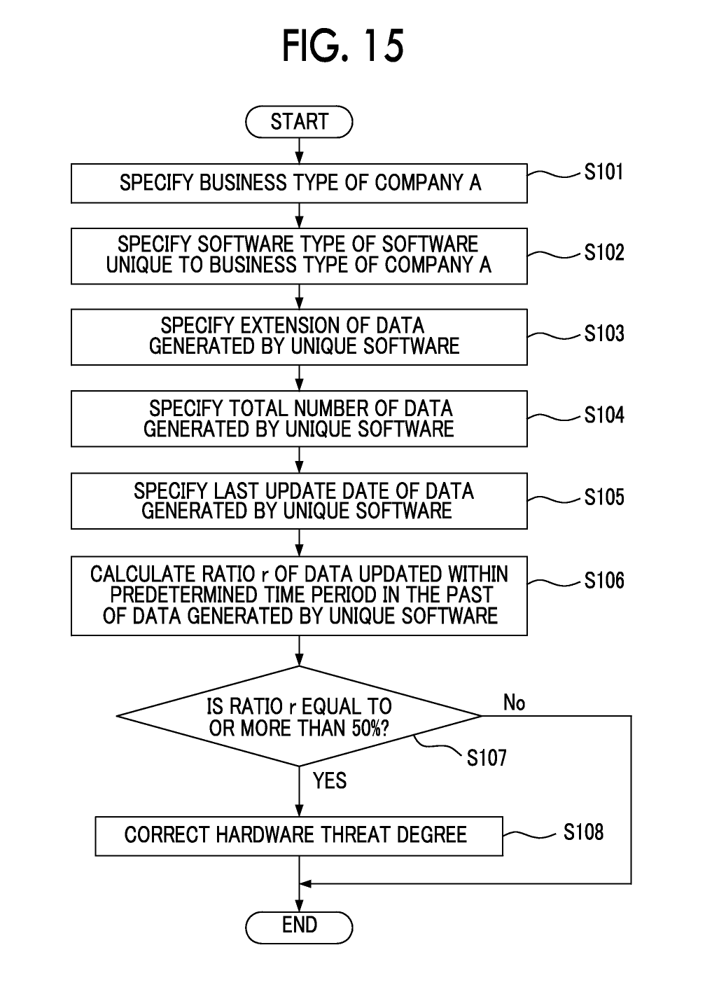

However, in a case where data generated by the software unique to the business type of the company A is stored on the hard disk depending on cases, the hardware threat determination portion 8 corrects a value of the hardware threat degree by performing a correction process exemplified in the flowchart of FIG. 15. In other words, the hardware threat determination portion 8 (attribute specifying unit) specifies a business type of the company A from values of the “business type” of the noted customer information (S101). In addition, the hardware threat determination portion 8 specifies a software type of software (hereinafter, referred to as unique software) unique to the business type of the company A by referring to the business type software table shown in FIG. 10 (S102). That is to say, the hardware threat determination portion 8 acquires a software type correlated with a condition which is satisfied by the business type specified in step S101 by referring to the business type software table (S102). Further, the hardware threat determination portion 8 specifies a so-called extension of data generated by the unique software (S103). The hardware threat determination portion 8 (first specifying portion) specifies a total number N1 of data which is reserved on the hard disk and is generated by the unique software (S104) and specifies the last update date of the data (S105) on the basis of the apparatus information “list of data reserved on the hard disk and the last update date” of the noted customer information. In addition, the hardware threat determination portion 8 (second specifying portion) specifies the number N2 of data updated within a predetermined time period (here, for a week) in the past of the data which is reserved on the hard disk and is generated by the unique software on the basis of the last update date specified in step S105, and calculates a ratio r of N2 to N1 (S106). Further, the hardware threat determination portion 8 determines whether or not the ratio r is equal to or more than 50% (S107), and corrects the hardware threat degree (S108) if the ratio r is equal to or more than 50% (YES in S107). In other words, if the ratio r is equal to or more than 50%, the hardware threat determination portion 8 multiplies the hardware threat degree by a predefined value “1.1”.

In this way, the hardware threat degree is calculated.

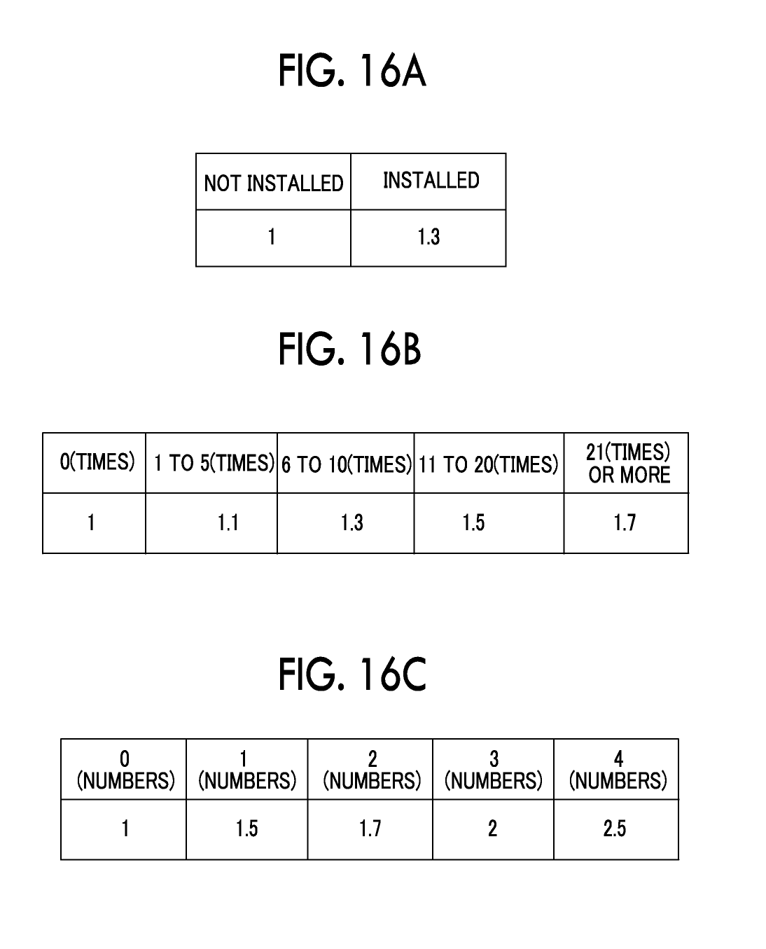

In addition, the information leak threat determination portion 9 determines a threat degree on the basis of the “whether or not file sharing software is installed”, the “times of data writings in the USB storage device per day”, and the “number of ports to which the file sharing software listens” in the apparatus information of the noted customer information. More specifically, the information leak threat determination portion 9 reads a file sharing software evaluation table which holds fundamental evaluation values in correlation with conditions regarding values of the apparatus information “whether or not file sharing software is installed” from the hard disk, and acquires a fundamental evaluation value correlated with a condition which is satisfied by a value of the “whether or not file sharing software is installed” of the noted customer information. FIG. 16A exemplifies the file sharing software evaluation table. In addition, the information leak threat determination portion 9 reads a times-of-writings evaluation table which holds fundamental evaluation values in correlation with conditions regarding values of the apparatus information “times of data writings in the USB storage device per day” from the hard disk, and acquires a fundamental evaluation value correlated with a condition which is satisfied by a value of the “times of data writings in the USB storage device per day” of the noted customer information. FIG. 16B exemplifies the times-of-writings evaluation table. Further, the information leak threat determination portion 9 reads a number-of-ports evaluation table which holds fundamental evaluation values in correlation with conditions regarding values of the apparatus information “number of ports to which the file sharing software listens” from the hard disk, and acquires a fundamental evaluation value correlated with a condition which is satisfied by a value of the “number of ports to which the file sharing software listens” of the noted customer information. FIG. 16C exemplifies the number-of-ports evaluation table. The information leak threat determination portion 9 calculates a product of the fundamental evaluation values acquired from the file sharing software evaluation table, the times-of-writings evaluation table, and the number-of-ports evaluation table as an information leak threat degree. A sum of the information leak threat degree calculated in this way, the virus infection threat degree, and the hardware threat degree is a threat degree of the information collection target apparatus X.

Company Risk Determination Unit and Information Output Unit

The company risk determination unit 4d adds a sum total of the importances which are calculated by the importance determination unit 4b for the respective pieces of customer information stored in the customer information memory 4a to a sum total of the threat degrees which are calculated by the threat determination unit 4c for the respective pieces of customer information stored in the customer information memory 4a, thereby calculating an evaluation value indicating an evaluation of the risk which the company A has as a company. In addition, the information output unit 4e outputs the evaluation value calculated by the company risk determination unit 4d to the display. This evaluation value is referred to, for example, when setting company policies of the company A. Further, information output by the information output unit 4e is not limited only to the evaluation value. For example, the information output unit 4e may output a sum total of the importances calculated by the importance determination unit 4b or may output a sum total of the virus infection threat degrees calculated by the threat determination unit 4c.

In addition, embodiments of the invention are not limited only to the above-described embodiment.

For example, the “hard disk” may not only include a hard disk embedded in the information collection target apparatus 2 but also include a network-attached storage connected to the information collection target apparatus 2 via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
an importance generation unit that generates importance information indicating an importance of an information processing apparatus on the basis of first apparatus information regarding the information processing apparatus, collected from the information processing apparatus;
a crisis degree generation unit that generates crisis degree information indicating a level of a crisis which the information processing apparatus possibly suffers on the basis of second apparatus information regarding the information processing apparatus, collected from the information processing apparatus; and
an evaluation unit that calculates an evaluation value on the basis of the importance information generated by the importance generation unit and the crisis degree information generated by the crisis degree generation unit.

2. The information processing device according to claim 1, wherein the first apparatus information is information indicating a hardware performance, and
wherein the importance generation unit generates the importance information on the basis of a hardware performance of the information processing apparatus collected from the information processing apparatus and a hardware performance of another information processing apparatus collected from another information processing apparatus.

3. The information processing device according to claim 1, wherein the first apparatus information is information indicating a software type of installed software,
wherein the information processing device further comprises:
an attribute specifying unit that specifies an attribute of a user possessing the information processing apparatus,
wherein a software type is correlated with a condition regarding an attribute, and
wherein the importance generation unit generates the importance information on the basis of whether or not a software type correlated with a condition which is satisfied by an attribute of the user is the same as a software type indicated by the first apparatus information.

4. The information processing device according to claim 1, wherein the second apparatus information is information indicating hardware usage,
wherein a software type is correlated with a condition regarding an attribute,
wherein the information processing device further comprises:
an attribute specifying unit that specifies an attribute of a user possessing the information processing apparatus, and
wherein the crisis degree generation unit comprises:
a first specifying portion that specifies the number of items of data which are stored in a storage device of the information processing apparatus and is generated by software of a software type correlated with a condition satisfied by an attribute of the user;
a second specifying portion that specifies the number of items of data updated within a predetermined time period in the past of the data stored in the storage device; and
a generation portion that generates the importance information on the basis of hardware usage indicated by the second apparatus information and whether or not a ratio of the number specified by the second specifying portion to the number specified by the first specifying portion is equal to or more than a reference value.

5. A non-transitory computer readable medium storing a program causing a computer to function as:
an importance generation unit that generates importance information indicating an importance of an information processing apparatus on the basis of first apparatus information regarding the information processing apparatus, collected from the information processing apparatus;
a crisis degree generation unit that generates crisis degree information indicating a level of a crisis which the information processing apparatus possibly suffers on the basis of second apparatus information regarding the information processing apparatus, collected from the information processing apparatus; and
an evaluation unit that calculates an evaluation value on the basis of the importance information generated by the importance generation unit and the crisis degree information generated by the crisis degree generation unit.

6. An information processing method comprising:
generating importance information indicating an importance of an information processing apparatus on the basis of first apparatus information regarding the information processing apparatus, collected from the information processing apparatus;
generating crisis degree information indicating a level of a crisis which the information processing apparatus possibly suffers on the basis of second apparatus information regarding the information processing apparatus, collected from the information processing apparatus; and
calculating an evaluation value on the basis of the importance information and the crisis degree information.
